(19) United States
(12) Patent Application Publication
(10) Pub. No.: US 2016/0169102 A1
(43) Pub. Date: Jun. 16, 2016

(54) REVERSE CORE FLOW GAS TURBINE ENGINE

(71) Applicant: United Technologies Corporation, Farmington, CT (US)

(72) Inventors: Paul R. Hanrahan, Farmington, CT (US); Daniel Bernard Kupratis, Wallingford, CT (US)

(21) Appl. No.: 14/948,991

(22) Filed: Nov. 23, 2015

Related U.S. Application Data
(60) Provisional application No. 62/091,035, filed on Dec. 12, 2014.

(51) Int. Cl. F02C 3/14; F02C 3/107; F02C 7/12; F02C 3/06

(52) U.S. Cl. CPC F02C 3/145; F02C 3/06; F02C 3/107; F02C 7/12; F05D 2220/32; F05D 2240/24; F05D 2240/35

(57) ABSTRACT

A reverse flow gas turbine engine includes a propulsor section which includes a propulsor compressor section and a propulsor turbine section. The propulsor section includes a fan section and a geared architecture. The fan section is driven by the propulsor turbine section. A core section is arranged fluidly between the propulsor compressor section and the propulsor turbine section. The core section includes a reverse flow duct that reverses a core flow through the core section. At least one of the propulsor section and the core section has a two-spool arrangement.

### CROSS-REFERENCE TO RELATED APPLICATIONS

This application claims priority to U.S. Provisional Application No. 62/091,035, which was filed on Dec. 12, 2014 and is incorporated herein by reference.

### BACKGROUND

This disclosure relates to a reverse core flow gas turbine engine with efficient propulsor and core section arrangements.

Gas turbine engines typically include a compressor section, a combustor section and a turbine section. During operation, air is pressurized in the compressor section and is mixed with fuel and burned in the combustor section to generate hot combustion gases. The hot combustion gases are communicated through the turbine section, which extracts energy from the hot combustion gases to power the compressor section and other gas turbine engine loads, such as a fan section.

The fan section is arranged in a bypass flow path. The core section, which is fluidly downstream from the fan section, provides a core flow path. The compressor section, combustor section and turbine section is arranged in the core flow path.

One typical gas turbine engine architecture provides its compressor section, combustor section and turbine section axially with respect to one another. Another type of engine, referred to as a reverse core flow gas turbine engine, includes a propulsor section in addition to the core section. The core flow is turned 180° to flow in a forward direction, which is the opposite of a typical engine, before being exhausted into the bypass flow path. A reverse core flow engine has some potential advantages over a typical gas turbine engine, which may provide some additional engine operating efficiency. It is desirable to further improve the efficiency of reverse core flow gas turbine engines.

### SUMMARY

In one exemplary embodiment, a reverse flow gas turbine engine includes a propulsor section which includes a propulsor compressor section and a propulsor turbine section. The propulsor section includes a fan section and a geared architecture. The fan section is driven by the propulsor turbine section. A core section is arranged fluidly between the propulsor compressor section and the propulsor turbine section. The core section includes a reverse flow duct that reverses a core flow through the core section. At least one of the propulsor section and the core section has a two-spool arrangement.

In a further embodiment of the above, the core section includes a core compressor section and a core turbine section. The core compressor section includes low and high pressure core compressors. The core turbine section includes low and high pressure core turbines. The low pressure core compressor and the low pressure core turbine are mounted on a low speed core spool. The high pressure core compressor and the high pressure core turbine are mounted on a high speed core spool that is concentric with the low speed core spool.

In a further embodiment of any of the above, the core section includes a combustor section that is fluidly arranged between the high pressure core compressor and the high pressure core turbine.

In a further embodiment of any of the above, the reverse flow duct is fluidly arranged between the propulsor compressor section and the low pressure core compressor.

In a further embodiment of any of the above, an intercooler is arranged upstream from the reverse flow duct and downstream from the propulsor compressor section.

In a further embodiment of any of the above, the intercooler extends a substantial portion of a total axial length of the core section.

In a further embodiment of any of the above, the intercooler is a tube heat exchanger.

In a further embodiment of any of the above, the intercooler provides the reverse flow duct.

In a further embodiment of any of the above, the propulsor turbine section includes a power turbine and a propulsor turbine that are fluidly arranged downstream from the power turbine. The power turbine is mounted to a high speed propulsor spool. The propulsor turbine is mounted to a low speed propulsor spool.

In a further embodiment of any of the above, the fan section is driven by at least one of the power turbine and propulsor turbine through the geared architecture.

In a further embodiment of any of the above, the fan section, the propulsor compressor section and the core compressor section provides an overall pressure ratio of 100 or greater.

In a further embodiment of any of the above, each of the low and high speed core spools and the high speed propulsor spool provides a compression ratio of greater than or equal to 3:1, but less than or equal to 6:1.

In a further embodiment of any of the above, there is an engine static structure. The geared architecture is an epicyclic gear train. The epicyclic gear train includes a sun gear that intermeshes with intermediate gears that are mounted to a carrier. A ring gear surrounds and intermeshes with the intermediate gears.

In a further embodiment of any of the above, the power turbine drives the sun gear. The ring gear is grounded to the engine static structure. The carrier drives the fan.

In a further embodiment of any of the above, the power turbine drives the sun gear. The carrier drives the propulsor compressor and the propulsor turbine. The ring gear drives the fan.

In a further embodiment of any of the above, the power turbine drives the sun gear. The carrier is grounded to the engine static structure. The ring gear drives the fan, propulsor compressor, and the propulsor turbine.

In a further embodiment of any of the above, the power turbine drives the sun gear. The carrier is grounded to the engine static structure. The ring gear drives the fan.

In a further embodiment of any of the above, the power turbine drives the sun gear. The ring gear is grounded to the engine static structure. The carrier drives the fan, propulsor compressor, and the propulsor turbine.

In a further embodiment of any of the above, the power turbine drives the sun gear. The carrier drives the propulsor compressor and the propulsor turbine. The ring gear drives the fan.

In a further embodiment of any of the above, the power turbine drives the carrier. The sun gear drives the propulsor compressor and the propulsor turbine. The ring gear drives the fan.

### BRIEF DESCRIPTION OF THE DRAWINGS

The disclosure can be further understood by reference to the following detailed description when considered in connection with the accompanying drawings wherein:

FIG. 1 schematically illustrates a reverse flow gas turbine engine embodiment with a geared architecture and an intercooler.

FIG. 2 schematically illustrates a reverse flow gas turbine engine embodiment similar to that shown in FIG. 1, but with another geared architecture.

FIG. 3A schematically illustrates a reverse flow gas turbine engine embodiment similar to that shown in FIG. 1, but with another intercooler.

FIG. 3B schematically illustrates a cross-section of the intercooler shown in FIG. 3A.

FIG. 4A schematically depicts the geared architecture shown in FIGS. 1 and 3A.

FIG. 4B schematically depicts the geared architecture shown in FIG. 2.

FIG. 4C schematically depicts another geared architecture embodiment.

FIG. 4D schematically depicts another geared architecture embodiment.

FIG. 4E schematically depicts another geared architecture embodiment.

FIG. 4F schematically depicts another geared architecture embodiment.

FIG. 4G schematically depicts another geared architecture embodiment.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### DETAILED DESCRIPTION

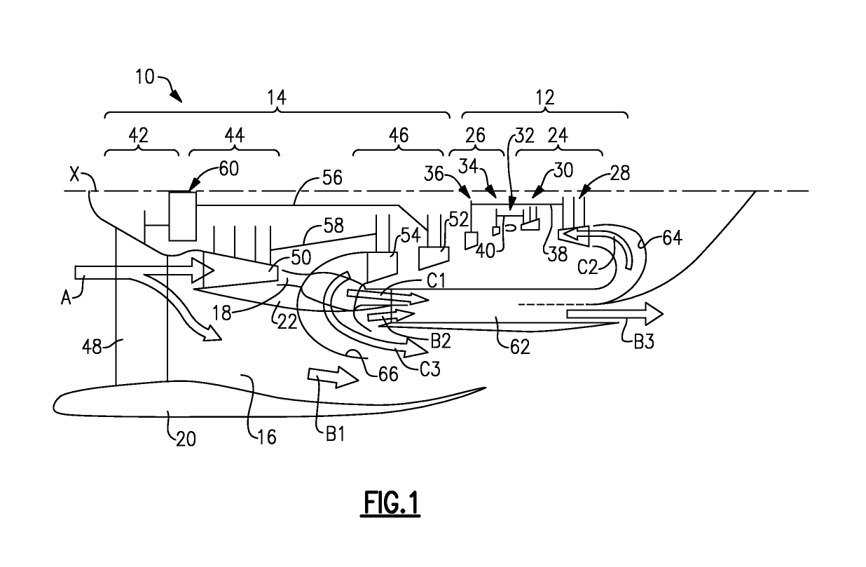

FIG. 1 schematically illustrates a reverse core flow gas turbine engine 10. The gas turbine engine 10 disclosed herein has a core section 12 and a propulsor section 14. Alternative engines might include an augmenter section (not shown) among other systems or features. The core section includes a core flow path 18. A bypass flow path 16 is provided between fan and core nacelles 20, 22 and circumscribes the core flow path 18.

The core section 12 includes a core compressor section 24, and a core turbine section 26 is arranged fluidly downstream from the core compressor section 24. The core compressor section 24 includes first (low pressure) core and second (high pressure) core 28, 30 compressors respectively mounted on concentric first (low speed) and second (high speed) core spools 38, 40, which are in a two-spool arrangement. A combustor section 32 is arranged axially between the core compressor and core turbine sections 24, 26. The core turbine section 26 includes first (high pressure) and second (low pressure) core turbines 34, 36 mounted to the high and low speed core spools 40, 38, respectively. Each of the core compressors 28, 30 and core turbines 34, 36 includes one or more fixed and/or rotating stages.

The propulsor section 14 includes a fan section 42, a propulsor compressor section 44 and a propulsor turbine section 46. The propulsor fan section 42 includes a fan 48 arranged in the bypass flow path 16. The propulsor compressor section 44 includes a propulsor compressor 50 immediately fluidly downstream from the fan 48. The propulsor turbine section 46 includes a power turbine 52 and a propulsor turbine 54 arranged fluidly downstream from the power turbine 52. The propulsor section 14 has a two-spool arrangement in which the power turbine 52 is mounted on a first (high) propulsor spool 56 and the propulsor compressor 50 and propulsor turbine 54 is mounted on a second (low) propulsor spool 58.

In one embodiment, the fan 42 provides a substantial amount of thrust provided by the engine 10. That is, a significant amount of thrust is provided by the bypass flow due to a high bypass ratio compared to the core flow. The fan section 42 of the engine 10 is designed for a particular flight condition—typically cruise at about 0.8 Mach and about 35,000 feet (10,668 meters). The flight condition of 0.8 Mach and 35,000 ft (10,668 meters), with the engine at its best fuel consumption—also known as “bucket cruise Thrust Specific Fuel Consumption (‘TSFC’)”—is the industry standard parameter of lbm of fuel being burned divided by lbf of thrust the engine produces at that minimum point. “Low fan pressure ratio” is the pressure ratio across the fan blade alone, without a Fan Exit Guide Vane (“FEGV”) system.

The fan section 42 has a low fan pressure ratio, which is disclosed herein according to one non-limiting embodiment as less than about 1.55. In another non-limiting embodiment the low fan pressure ratio is less than about 1.45. In another non-limiting embodiment the low fan pressure ratio is from 1.1 to 1.45. “Low corrected fan tip speed” is the actual fan tip speed in ft/sec divided by an industry standard temperature correction of [(Tram ° R)/(518.7° R)]^{0.5}. The “Low corrected fan tip speed” as disclosed herein according to one non-limiting embodiment is less than about 1200 ft/second (365.7 meters/second).

A geared architecture 60 is coupled to the fan 48 to reduce the speed of the fan. The engine 10 in one example is a high-bypass geared aircraft engine. In a further example, the engine 10 bypass ratio is greater than about six (6:1), with an example embodiment being greater than about ten (10:1). The geared architecture 60 may be an epicyclic gear train, such as a planetary gear system, star gear system, differential gear system or other gear system. In one example, the geared architecture provides a gear reduction ratio of greater than about 2.3:1. It should be understood, however, that the above parameters are only exemplary of one embodiment of a geared architecture engine and that the present arrangement is applicable to other gas turbine engines including direct drive turbofans.

During engine operation, air A enters the engine 10 and flows into the bypass and core flow paths 16, 18. The fan section 42 drives air along the bypass flow path 16 in a bypass duct defined within the fan nacelle 20, while the propulsor compressor section 44 drives core flow C1 along the core flow path 18 for further compression and communication in the core section 12.

Most of the bypass flow B1 travels through the bypass flow path 16 to provide propulsion. Some of the bypass flow B2 is diverted to an intercooler 62, which cools the compressed air from the propulsor compressor 50, before the bypass flow B3 is expelled from the engine to supplement the propulsive effect of the bypass flow B1.

The cooled compressed core flow C2 turns 180° through the reverse duct 64 and enters the core compressor section 24. The core flow C2 is compressed by the low pressure core compressor 28 then the high pressure core compressor 30, mixed and burned with fuel in the combustor 32, then expanded over the high pressure core turbine 34 and low pressure core turbine 36. The core turbines 36, 34 rotationally drive the respective low speed spool 38 and high speed spool 40 in response to the expansion.

The expanding core flow C3 passes through the propulsor turbine section 46, first through the power turbine 52 and then the propulsor turbine 54. In the embodiment shown in FIG. 1, the power turbine 52 rotationally drives the fan section 42 through the geared architecture 60, and the propulsor turbine 54 rotationally drives the propulsor compressor 50. The core flow C3 is turned 180° and expelled into the bypass flow path 16.

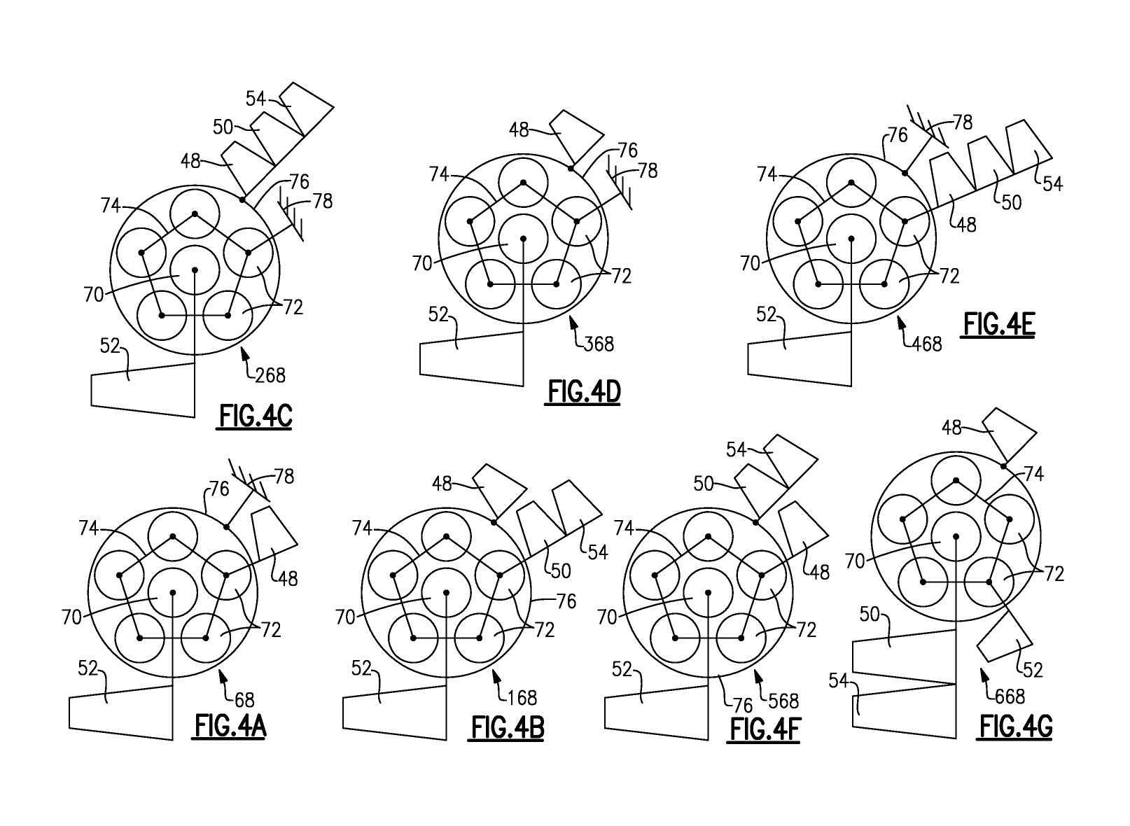

One example geared architecture 60 is shown in more detail in FIG. 4A. The geared architecture is an epicyclic gear train 68. The epicyclic gear train 68 includes a sun gear 70 intermeshing with intermediate gears 72 mounted to a carrier 74. A ring gear 76 surrounds and intermeshes with the intermediate gears 72. With reference to FIGS. 1 and 4A, the power turbine 52 drives the sun gear 70, and the ring gear 76 is grounded to the engine static structure 78. The carrier 74 drives the fan 48.

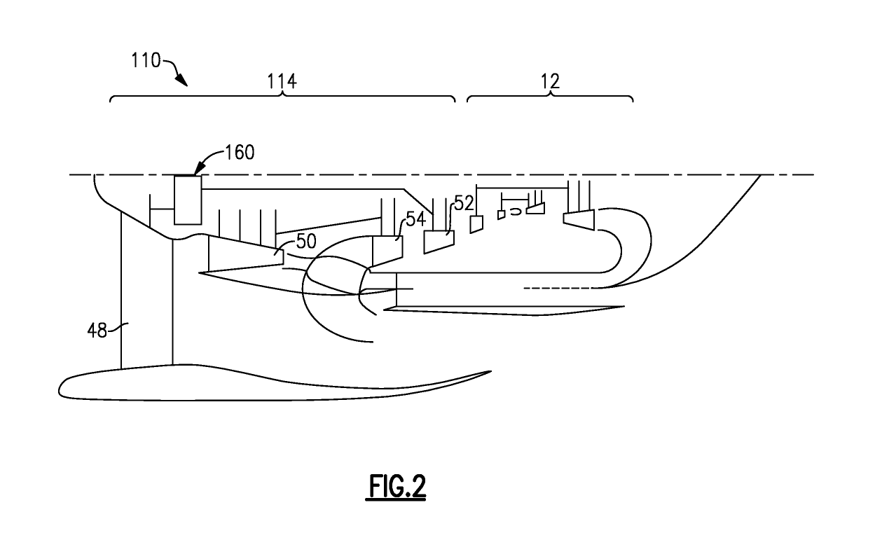

Referring to the engine 110 in FIG. 2, the propulsor section 114 includes a differential geared architecture 160, which is shown in more detail as epicyclic gear train 168 in FIG. 4B. The power turbine 52 drives the sun gear 70. The carrier 74 drives the propulsor compressor and turbine 50, 54, and the ring gear 76 drives the fan 48.

Other epicyclic gear trains 268, 368, 468, 568, 668 are shown in FIGS. 4C-4G. Referring to FIG. 4C, the power turbine 52 drives the sun gear 70. The carrier 74 is grounded to the engine static structure 78, and the ring gear 76 drives the fan 48 and propulsor compressor and turbine 50, 54. Referring to FIG. 4D, the power turbine 52 drives the sun gear 70. The carrier 74 is grounded to the engine static structure 78, and the ring gear 48 drives the fan 48. Referring to FIG. 4E, the power turbine 52 drives the sun gear 70. The ring gear 76 is grounded to the engine static structure 78, and the carrier 74 drives the fan 48 and propulsor compressor and turbine 50, 54. Referring to FIG. 4F, the power turbine drives the sun gear 70. The carrier 74 drives the fan 48, and the ring gear 76 drives the propulsor compressor and turbine 50, 54. Referring to FIG. 4G, the power turbine 52 drives the carrier 74. The sun gear 70 drives the propulsor compressor and turbine 50, 54, and the ring gear drives the fan 48. In this configuration, the shaft 56 of the turbine 52 is nested concentrically inside the spool 58. The shaft 56 passes inside the bore of the sun gear 70 and reaches to the front side of the gear train 668 and connects to the planet carrier 74.

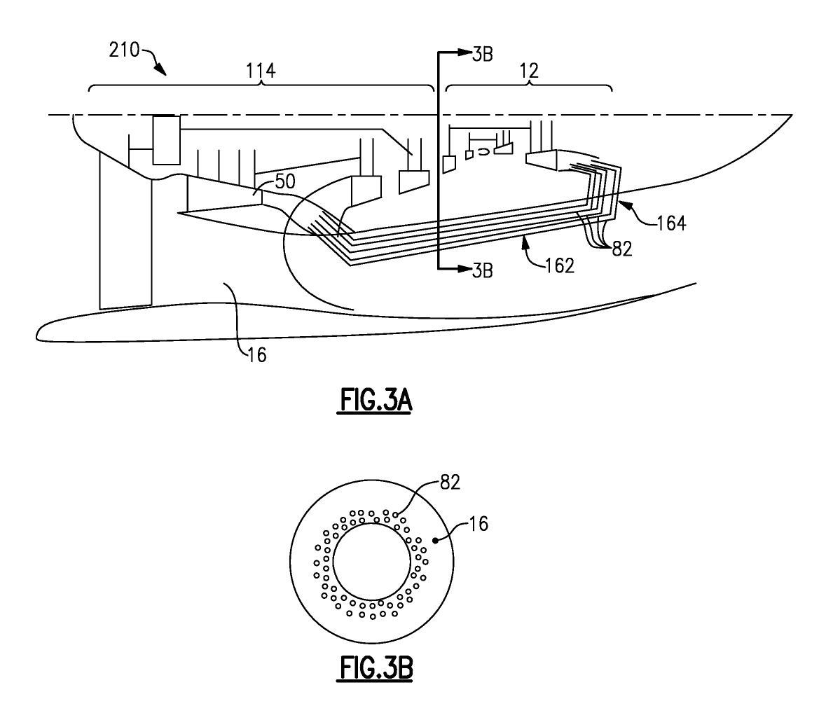

The intercooler 62 may be any suitable configuration, such as an annular duct, as shown in FIGS. 1 and 2. In the example, the intercooler 62 extends a substantial portion of a total axial length of the core section 12, for example, more than 50%. A tube heat exchanger configuration is shown in FIGS. 3A and 3B as one example alternative. The intercooler 162 includes multiple tubes 82 that are arranged in the bypass flow path 16 to provide increased surface area and improved cooling of the core flow entering the core section 12. The tubes 82 can be arranged in any desired configuration and provides the reverse duct 164 in the example.

In one example embodiment, the engine 10 has an overall pressure ratio (OPR) of about 100 or greater at operating temperatures similar to conventional non-reverse core flow gas turbine engines. The OPR is the total compression through the fan section 42, the propulsor compressor section 44 and the core compressor section 24. High OPR's enable smaller engine core sizes. Each compressor 50, 28, 30 provides a substantively similar pressure ratio, for example, greater than or equal to 3:1 but less than or equal to 6:1, and in another example, nominally 4:1 or 5:1. This low per-spool compression minimizes the number of variable vanes for maximum efficiency, and minimizes the total number of airfoils for reduced cost.

Each of the core and propulsor sections 12, 14 has a pair of nested spools 38, 40 and 56, 58. This minimizes the axial distance between each spool's compressor and turbine, 48 to 52, 50 to 54, 28 to 36, and 30 to 34, to avoid any rotordynamic issues that are inherent in the long shafts necessitated by long compressors or by nesting three or more spools. This arrangement also permits the rear engine mount to be placed in front of the smallest spools 38 and 40, removing them from the backbone bending of the engine static structure. With minimal structural bending, tighter tip clearances and improved aerodynamic efficiency can be maintained.

It should also be understood that although a particular component arrangement is disclosed in the illustrated embodiment, other arrangements will benefit herefrom. Although particular step sequences are shown, described, and claimed, it should be understood that steps may be performed in any order, separated or combined unless otherwise indicated and will still benefit from the present invention.

Although the different examples have specific components shown in the illustrations, embodiments of this invention are not limited to those particular combinations. It is possible to use some of the components or features from one of the examples in combination with features or components from another one of the examples.

Although an example embodiment has been disclosed, a worker of ordinary skill in this art would recognize that certain modifications would come within the scope of the claims. For that reason, the following claims should be studied to determine their true scope and content.

What is claimed is:

1. A reverse flow gas turbine engine comprising:
a propulsor section includes a propulsor compressor section and a propulsor turbine section, wherein the propulsor section includes a fan section and a geared architecture, the fan section driven by the propulsor turbine section; and
a core section is arranged fluidly between the propulsor compressor section and the propulsor turbine section, the core section includes a reverse flow duct that reverses a core flow through the core section, wherein at least one of the propulsor section and the core section has a two-spool arrangement.

2. The engine according to claim 1, wherein the core section includes a core compressor section and a core turbine section, the core compressor section includes low and high pressure core compressors, and the core turbine section includes low and high pressure core turbines, the low pressure core compressor and the low pressure core turbine mounted on a low speed core spool, and the high pressure core compressor and the high pressure core turbine mounted on a high speed core spool that is concentric with the low speed core spool.

3. The engine according to claim 2, wherein the core section includes a combustor section fluidly arranged between the high pressure core compressor and the high pressure core turbine.

4. The engine according to claim 2, wherein the reverse flow duct is fluidly arranged between the propulsor compressor section and the low pressure core compressor.

5. The engine according to claim 4, comprising an intercooler arranged upstream from the reverse flow duct and downstream from the propulsor compressor section.

6. The engine according to claim 5, wherein the intercooler extends a substantial portion of a total axial length of the core section.

7. The engine according to claim 5, wherein the intercooler is a tube heat exchanger.

8. The engine according to claim 7, wherein the intercooler provides the reverse flow duct.

9. The engine according to claim 2, wherein the propulsor turbine section includes a power turbine and a propulsor turbine fluidly arranged downstream from the power turbine, power turbine mounted to a high speed propulsor spool, and the propulsor turbine mounted to a low speed propulsor spool.

10. The engine according to claim 9, wherein the fan section is driven by at least one of the power turbine and propulsor turbine through the geared architecture.

11. The engine according to claim 9, wherein the fan section, the propulsor compressor section and the core compressor section provides an overall pressure ratio of 100 or greater.

12. The engine according to claim 11, wherein each of the low and high speed core spools and the high speed propulsor spool provides a compression ratio of greater than or equal to 3:1, but less than or equal to 6:1.

13. The engine according to claim 9, comprising an engine static structure, wherein the geared architecture is an epicyclic gear train, the epicyclic gear train includes a sun gear intermeshing with intermediate gears mounted to a carrier, and a ring gear surrounds and intermeshes with the intermediate gears.

14. The engine according to claim 13, wherein the power turbine drives the sun gear, and the ring gear is grounded to the engine static structure, and the carrier drives the fan.

15. The engine according to claim 13, wherein the power turbine drives the sun gear, the ring gear drives the propulsor compressor and the propulsor turbine, and the carrier drives the fan.

16. The engine according to claim 13, wherein the power turbine drives the sun gear, the carrier is grounded to the engine static structure, and the ring gear drives the fan, propulsor compressor, and the propulsor turbine.

17. The engine according to claim 13, wherein the power turbine drives the sun gear, the carrier is grounded to the engine static structure, and the ring gear drives the fan.

18. The engine according to claim 13, wherein the power turbine drives the sun gear, the ring gear is grounded to the engine static structure, and the carrier drives the fan, propulsor compressor, and the propulsor turbine.

19. The engine according to claim 13, wherein the power turbine drives the sun gear, the carrier drives the propulsor compressor and the propulsor turbine, and the ring gear drives the fan.

20. The engine according to claim 13, wherein the power turbine drives the carrier, the sun gear drives the propulsor compressor and the propulsor turbine, and the ring gear drives the fan.
